(19) United States
(12) Patent Application Publication
(10) Pub. No.: US 2026/0171514 A1
(43) Pub. Date: Jun. 18, 2026

(54) BATTERY MANAGEMENT SYSTEM, METHOD AND SYSTEM TO REDUCE POWER CONSUMPTION

(71) Applicant: CPS Technology Holdings LLC, New York, NY (US)

(72) Inventors: Daryl C. BROCKMAN, Shorewood, WI (US); Tao ZHANG, Shanghai (CN)

(21) Appl. No.: 19/125,443

(22) PCT Filed: Oct. 31, 2023
(86) PCT No.: PCT/CN2023/128421

§ 371 Date: Apr. 29, 2025

(30) Foreign Application Priority Data
Oct. 31, 2022 (WO) PCT/CN2022/128618

(51) Int. Cl. H01M 10/42

(52) U.S. Cl. CPC H01M 10/425; H01M 2010/4271; H01M 2220/20

(57) ABSTRACT

A battery management system (BMS) removably connectable to at least one of a battery and an accessory is described. The accessory is operable by the BMS. The BMS includes processing circuitry configured to determine a first plurality of functions associated with the BMS and a second plurality of functions associated with the accessory based on BMS information and accessory information, respectively, determine at least one operation mode based on at least one parameter associated with the battery, the first plurality of functions, and the second plurality of functions, and operate at least one of the BMS and the accessory based on the determined at least one operation mode.

### TECHNICAL FIELD

This disclosure relates to a method and system for power management of an energy storage module (e.g., battery such as a lithium battery).

### BACKGROUND

Motor-powered and/or electrically powered vehicles tend to rely on using one or more battery systems for providing a starting power (e.g., power used to crank and start an engine) and/or at least a portion of a motion power for the vehicle. Such vehicles may include one or more of an air-or watercraft, a rail-guided vehicle, a street vehicle, etc., where a street vehicle may refer to, for example, cars, trucks, buses, recreational vehicles, etc.

In vehicles, different types of batteries (e.g., energy storage modules) are used, such as traction batteries (for electric or hybrid electric vehicles) and starter batteries. In automotive applications, for example, a starter battery is used for providing the necessary energy/power required for starting a vehicle where a traction battery may generally refer to a battery which provides motive power to the vehicle, for example.

Further, batteries may be arranged to also provide power to other systems such as accessory systems in a vehicle and/or the battery. When a battery is powering such other systems without the battery being charged (e.g., by an external charger, by a running engine and corresponding alternator system, etc.), the state of charge of the battery decreases with time at a greater rate than when battery is not powering such other systems. For example, some batteries may have power indicator lights indicating a state of charge of the battery. Although power consumption of indicator lights may appear to be negligible (e.g., compared to the power required to start an engine or power an accessory), the power consumption of indicator lights may be sufficient to fully discharge the battery after an interval of time if the battery is not re-charged. The interval of time for the discharge to occur is typically shorter than when the battery is not powering indicator lights. Other systems that may similarly cause a battery to discharge.

In other words, existing battery-based systems lack battery management processes and/or components that adequately manage power consumption associated with systems powered by the battery such as accessory systems connected to the battery, e.g., when the battery is not being charged.

### SUMMARY

Some embodiments advantageously provide a method and system for power management of an energy storage module (e.g., lithium battery).

According to one aspect, a battery management system (BMS) is described. The BMS is removably connectable to at least one of a battery and an accessory. The accessory is operable by the BMS, and the BMS comprises processing circuitry configured to determine at least one operation mode based on at least one parameter associated with the battery and operate at least one of the BMS and the accessory based on the determined at least one operation mode.

In some embodiments, the at least one operation mode includes at least one of a first operation mode corresponding to a first range of the at least one parameter; a second operation mode corresponding to a second range of the at least one parameter; and a third operation mode corresponding to third range of the at least one parameter.

In some other embodiments, the processing circuitry is further configured to at least one of determine a first time interval and a second time interval for at least one of the first, second, and third operation modes based on the at least one parameter, where the first time interval indicates the BMS is to be on during the first time interval, the second time interval indicates the BMS is to be on a BMS sleep state during the second time interval, and the first and second time intervals are consecutive; and determine a third time interval and a fourth time interval for at least one of the first, second, and third operation modes based on the at least one parameter. The third time interval indicates the accessory is to be on during the third time interval, and the fourth time interval indicates the accessory is to be off during the fourth time interval. The third and fourth time intervals are consecutive.

In an embodiment, the operation of at least one of the BMS and the accessory includes operating the BMS based on the first and second time intervals; and operating the accessory based on the third and fourth time intervals.

In another embodiment, the processing circuitry is further configured to at least one of determine a power consumption for each one of the at least one operation mode and each one of the BMS and the accessory based on a parameter threshold associated with the at least one parameter; determine a battery operation time interval for which the battery can be operated until the parameter threshold is reached based on the determined power consumption; determine at least one other operation mode based on the power consumption and the battery operation time interval; and operate at least one of the BMS and the accessory based on the determined at least one other operation mode.

According to another aspect, a method in a method in a battery management system (BMS) removably connectable to at least one of a battery and an accessory. The accessory being operable by the BMS. The method comprises determining at least one operation mode based on at least one parameter associated with the battery; and operating at least one of the BMS and the accessory based on the determined at least one operation mode.

In some embodiments, the at least one operation mode includes at least one of a first operation mode corresponding to a first range of the at least one parameter; a second operation mode corresponding to a second range of the at least one parameter; and a third operation mode corresponding to third range of the at least one parameter.

In some other embodiments, the method further includes at least one of determining a first time interval and a second time interval for at least one of the first, second, and third operation modes based on the at least one parameter, where the first time interval indicates the BMS is to be on during the first time interval, the second time interval indicates the BMS is to be on a BMS sleep state during the second time interval, and the first and second time intervals are consecutive; and determining a third time interval and a fourth time interval for at least one of the first, second, and third operation modes based on the at least one parameter. The third time interval indicates the accessory is to be on during the third time interval, and the fourth time interval indicates the accessory is to be off during the fourth time interval. The third and fourth time intervals are consecutive.

In an embodiment, the operation of at least one of the BMS and the accessory includes operating the BMS based on the first and second time intervals; and operating the accessory based on the third and fourth time intervals.

In another embodiment, the method further includes at least one of determining a power consumption for each one of the at least one operation mode and each one of the BMS and the accessory based on a parameter threshold associated with the at least one parameter; determining a battery operation time interval for which the battery can be operated until the parameter threshold is reached based on the determined power consumption; and determining at least one other operation mode based on the power consumption and the battery operation time interval; operating at least one of the BMS and the accessory based on the determined at least one other operation mode.

According to one aspect, a battery management system (BMS) removably connectable to at least one of a battery and an accessory is described. The accessory is operable by the BMS. The BMS includes processing circuitry configured to determine a first plurality of functions associated with the BMS and a second plurality of functions associated with the accessory based on BMS information and accessory information, respectively, determine at least one operation mode based on at least one parameter associated with the battery, the first plurality of functions, and the second plurality of functions, and operate at least one of the BMS and the accessory based on the determined at least one operation mode.

In some embodiments, the processing circuitry is further configured to at least one of determine a first time interval and a second time interval for the at least one operation mode based at least on the at least one parameter, the first and second time intervals being consecutive and determine a third time interval and a fourth time interval for the at least one operation mode based at least on the at least one parameter, the third and fourth time intervals being consecutive.

In some other embodiments, the operation of at least one of the BMS and the accessory includes operating the BMS based on the first time interval and the second time interval and operating the accessory based on the third time interval and the fourth time interval.

In some embodiments, at least one of: (A) operating the BMS based on the first time interval includes keeping the BMS on during the first time interval; (B)operating the BMS based on the second time interval includes keeping the BMS in a BMS sleep state during the first time interval; (C) operating the accessory based on the third time interval includes keeping the accessory on during the third time interval; and (D) operating the accessory based on the fourth time interval includes keeping the accessory in an accessory sleep state during the fourth time interval.

In some other embodiments, the processing circuitry is further configured to determine a first set of functions of the first plurality of functions associated with the BMS and a second set of functions of the second plurality of functions associated with the accessory based on a function characteristic of each one of the first of the first plurality of functions and the second plurality of functions.

In some embodiments, the function characteristic indicates at least one of a criticality level of the corresponding function and whether the function is associated with a battery health condition.

In some other embodiments, the processing circuitry is further configured to determine a frequency at which each function of the first plurality of functions and the second plurality of functions is to be performed based on at least one of the function characteristic, whether the function is in the first set or the second set, and power consumption of the function.

In some embodiments, the processing circuitry is further configured to perform at least one function of the first plurality of functions to operate the BMS and perform at least one function of the second plurality of functions to operate the accessory.

In some other embodiments, the processing circuitry is further configured to receive, from the accessory, an indication indicating a storage schedule of the battery, the at least one operation mode being determined further based on the storage schedule.

In some embodiments, the at least one operation mode includes at least one of: (A) a first operation mode corresponding to a first range of the at least one parameter, the first operation mode having a first power consumption of the BMS and a second power consumption of the accessory; (B) a second operation mode corresponding to a second range of the at least one parameter, the second operation mode having a third power consumption of the BMS and a fourth power consumption of the accessory; and (C) a third operation mode corresponding to third range of the at least one parameter. The third operation mode has a fifth power consumption of the BMS and a sixth power consumption of the accessory. Each power consumption of the BMS is different, and each power consumption of the accessory is different.

In some other embodiments, the first range includes a first plurality of values of the at least on parameter, the second range include a second plurality of values of the at least one parameter, the third range includes a third plurality of values of the at least one parameter. Each value of the second plurality of values is greater than each value of the first plurality of values, and each value of the third plurality of values is greater than each value of the second plurality of values.

In some embodiments, the processing circuitry is further configured to at least one of: (A) determine a power consumption for each one of the at least one operation mode and each one of the BMS and the accessory based on a parameter threshold associated with the at least one parameter; (B) determine a battery operation time interval for which the battery can be operated until the parameter threshold is reached based on the determined power consumption; (C) determine at least one other operation mode based on the power consumption and the battery operation time interval; and (D) before the operation time interval is reached, operate at least one of the BMS and the accessory based on the determined at least one other operation mode.

According to one aspect, a method in a battery management system (BMS) removably connectable to at least one of a battery and an accessory is described. The accessory is operable by the BMS. The method includes determining a first plurality of functions associated with the BMS and a second plurality of functions associated with the accessory based on BMS information and accessory information, respectively, determining at least one operation mode based on at least one parameter associated with the battery, the first plurality of functions, and the second plurality of functions, and operating at least one of the BMS and the accessory based on the determined at least one operation mode.

In some embodiments, the method further includes at least one of determining a first time interval and a second time interval for the at least one operation mode based at least on the at least one parameter, the first and second time intervals being consecutive and determining a third time interval and a fourth time interval for the at least one operation mode based at least on the at least one parameter, the third and fourth time intervals being consecutive.

In some other embodiments, the operation of at least one of the BMS and the accessory includes operating the BMS based on the first time interval and the second time interval and operating the accessory based on the third time interval and the fourth time interval.

In some embodiments, at least one of: (A) operating the BMS based on the first time interval includes keeping the BMS on during the first time interval; (B) operating the BMS based on the second time interval includes keeping the BMS in a BMS sleep state during the first time interval; (C) operating the accessory based on the third time interval includes keeping the accessory on during the third time interval; and (D) operating the accessory based on the fourth time interval includes keeping the accessory in an accessory sleep state during the fourth time interval.

In some other embodiments, the method further includes determining a first set of functions of the first plurality of functions associated with the BMS and a second set of functions of the second plurality of functions associated with the accessory based on a function characteristic of each one of the first of the first plurality of functions and the second plurality of functions.

In some embodiments, the function characteristic indicates at least one of a criticality level of the corresponding function and whether the function is associated with a battery health condition.

In some other embodiments, the method further includes determining a frequency at which each function of the first plurality of functions and the second plurality of functions is to be performed based on at least one of the function characteristic, whether the function is in the first set or the second set, and power consumption of the function.

In some embodiments, the method further includes performing at least one function of the first plurality of functions to operate the BMS and performing at least one function of the second plurality of functions to operate the accessory.

In some other embodiments, the method further includes receiving, from the accessory 20, an indication indicating a storage schedule of the battery. The at least one operation mode is determined further based on the storage schedule.

In some embodiments, the at least one operation mode includes at least one of: (A) a first operation mode corresponding to a first range of the at least one parameter, the first operation mode having a first power consumption of the BMS and a second power consumption of the accessory; (B) a second operation mode corresponding to a second range of the at least one parameter, where the second operation mode has a third power consumption of the BMS and a fourth power consumption of the accessory; and (C) a third operation mode corresponding to third range of the at least one parameter. The third operation mode has a fifth power consumption of the BMS and a sixth power consumption of the accessory. Each power consumption of the BMS is different, each power consumption of the accessory is different.

In some other embodiments, the first range includes a first plurality of values of the at least on parameter, the second range include a second plurality of values of the at least one parameter, and the third range includes a third plurality of values of the at least one parameter. Each value of the second plurality of values is greater than each value of the first plurality of values, and each value of the third plurality of values is greater than each value of the second plurality of values.

In some embodiments, the method further includes at least one of: (A) determining a power consumption for each one of the at least one operation mode and each one of the BMS and the accessory based on a parameter threshold associated with the at least one parameter; (B) determining a battery operation time interval for which the battery can be operated until the parameter threshold is reached based on the determined power consumption; (C) determining at least one other operation mode based on the power consumption and the battery operation time interval; and (D) before the operation time interval is reached, operating at least one of the BMS and the accessory based on the determined at least one other operation mode.

According to one aspect, a system is described. The system includes a battery, a battery management system (BMS) coupled to the battery, and an accessory coupled to the battery and the BMS. The accessory is operable by the BMS. The BMS includes processing circuitry configured to determine a first plurality of functions associated with the BMS and a second plurality of functions associated with the accessory based on BMS information and accessory information, respectively. The processing circuitry is further configured to determine a first set of functions of the first plurality of functions associated with the BMS and a second set of functions of the second plurality of functions associated with the accessory based on a function characteristic of each one of the first of the first plurality of functions and the second plurality of functions. The function characteristic indicate at least one of a criticality level of the corresponding function and whether the function is associated with a battery health condition. The processing circuitry is further configured to determine at least one operation mode based on at least one parameter associated with the battery, the first plurality of functions, the second plurality of functions, the first set of functions, the second set of functions. At least one of the BMS and the accessory is operated based on the determined at least one operation mode. The operation of at least one of the BMS and the accessory includes performing at least one function of the first set of functions or the first plurality of functions to operate the BMS and perform at least one function of the second set of functions or the second plurality of functions to operate the accessory.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a diagram of an example system according to principles disclosed herein;

FIG. 2 shows an example battery constructed in accordance with the principles of the present disclosure;

FIG. 3 is a block diagram of some entities in the system according to some embodiments of the present disclosure;

FIG. 4 shows an example BMS, battery, and accessory according to some embodiments of the present disclosure;

FIG. 5 is a flowchart of an example process in a battery device according to some embodiments of the present disclosure; and

FIG. 6 is a flowchart of another example process in a battery device according to some embodiments of the present disclosure.

### DETAILED DESCRIPTION

Before describing in detail exemplary embodiments, it is noted that the embodiments reside primarily in combinations of apparatus components and processing steps related to power management of an energy storage module (e.g., lithium battery). Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term “parameter” refers to any parameter related to a battery (and/or its components), battery performance, battery management, operation, vehicle parameters, accessory systems parameters, etc., as well as performance, management, operation, etc., of the device in which the battery is installed. In some embodiments the parameter may be an electrical parameter such as power, voltage, current, state of charge, resistance value and/or any other parameter such as temperature, pressure, frequency parameter (e.g., frequency of a pulse, frequency at which an operation mode is on and/or off and/or activated and/or deactivated), etc. A frequency parameter may refer to a time parameter such as the time a pulse is on or off, the time an operation mode is on/off and/or activated/deactivated. A parameter threshold may refer to a threshold associated with a parameter.

A battery health condition may refer to any condition associated with a battery (and/or devices, systems, components associated with the battery such as health of the battery and/or of a vehicle/vehicle system). A battery health condition may include a condition associated with one or more parameters, a failure (e.g., a catastrophic failure of a battery/system, a potential failure, a condition associated with a potential failure, triggered system failures, battery pack failure, fail to start/operate vehicle, etc.), a degradation condition (e.g., inability to meet a user/functional/specification requirement such as when a parameter is under/over a predetermined threshold), an internal short circuit, an internal resistance value being under a predetermined threshold (e.g. indicating a short circuit condition), etc.

An operation mode may refer to one or more modes of operating a battery and/or BMS and/or associated vehicle and/or associated system/device such as an accessory device. The operation mode may be based on one parameter such state of charge of the battery. Operation mode may comprise normal mode, active mode, inactive mode, sleep mode (or doze mode), active state, sleep state, shutdown mode, low power consumption mode, a high power consumption mode, etc. A normal node may include performing a plurality of functions (e.g., during an interval of time). An active mode may include performing at least one function (e.g., during an interval of time). Inactive mode may include not performing any functions (e.g., during an interval of time). Sleep mode may include not performing any functions (e.g., during an interval of time) and/or performing functions (e.g., during another interval of time). An active state may refer to a state corresponding to an active mode. A sleep state may refer to a state corresponding to the sleep mode. Shutdown mode may include a state subsequent to performing a shutdown action. A low power consumption mode may refer to an operation mode corresponding to power consumption that is lower than a predetermined threshold. A high power consumption mode may refer to an operation mode corresponding to power consumption that is equal to or greater than a predetermined threshold.

In some embodiments, the term function is used and may refer to a task, step, process, method, action, etc. that is performed such as by a system, device, etc.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

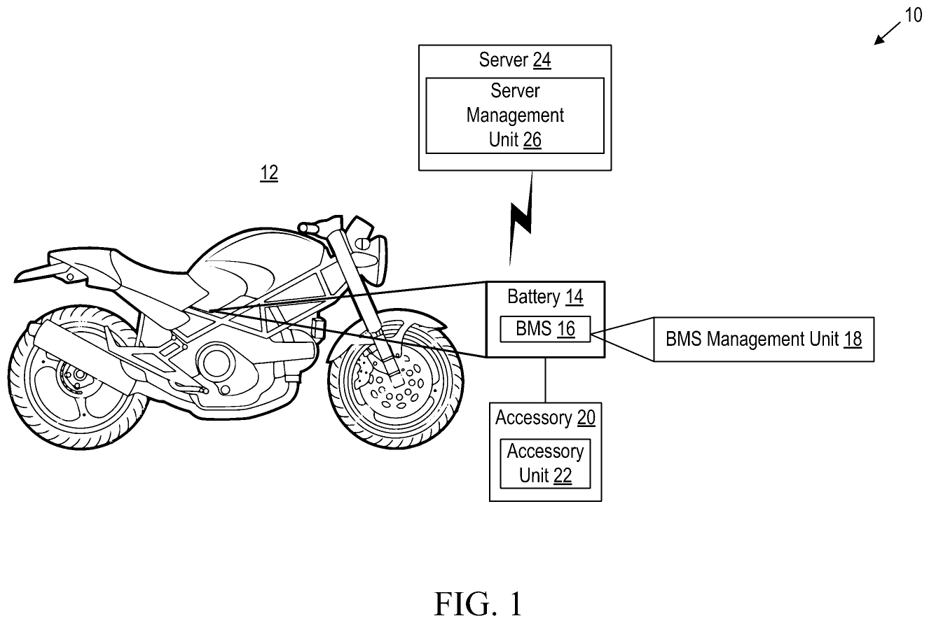

Referring to the drawing figures, in which like elements are referred to by like reference numerals, there is shown in FIG. 1 a diagram of a system 10, according to an embodiment, which comprises one or more vehicles 12. Although vehicle 12 is shown as a motorcycle, the present disclosure is not limited as such, and vehicle 12 may be any type of vehicle such as a car, scooter, golf cart, light utility vehicle, etc. The vehicle 12 comprises battery 14 for powering at least one function of vehicle 12. In some embodiments, battery 14 may be a lithium-ion based battery that includes one or more energy storage modules. Although a lithium-ion based battery has been described, the teachings described herein are equally applicable to other battery types. Battery 14 may include one or more batteries such as a first battery 14a, second battery 14b, third battery 14c, fourth battery 14d, etc., e.g., electrically connected (e.g., in parallel, series, etc.) as part of a battery pack. Battery 14 includes battery management system (BMS) 16 that is configured to perform one or more battery management functions described herein. In some embodiments, the BMS 16 may measure/determine certain battery parameters, e.g., current, state of charge (SOC), voltage, a time parameter, a frequency parameter, etc., and transmit/receive data (and/or signals such as control signals) to/from another system/device. A BMS 16 is configured to include a BMS management unit 18 that may be configured to perform one or more functions as described herein such as power perform management of battery 14, determine and/or select operation modes of battery 14 and/or BMS 16 and/or other devices/systems.

System 10 may further include accessory 20 comprising accessory unit 22 that may be configured to perform one or more functions as described herein such as provide one or more accessory functions, e.g., state of charge indication of battery 14, etc. Accessory 20 may be physically and/or electrically connected to one or more components of system 10 such as battery 14 and/or BMS 16. Accessory 20 may also be configured to receive parameters from the BMS 16 for accessory 20 perform actions based on the parameters. Further, accessory 20 may also be configured to provide parameters to the BMS 16 for BMS 16 to perform actions based on the parameters. The parameters may be provided by a user via accessory 20. For example, accessory 20 may also be configured to receive input form a user such as to display a parameter associated with battery 14 and/or BMS 16. More specifically, accessory 20 may be configured to receive a parameter from BMS 16 and display information associated with the parameter, e.g., an indication of state of charge determined by BMS 16. Further, accessory 20 may receive input from a user associated with an expected state of the battery 14, e.g., expected storage time, time period that battery 14 will not be charged, schedule of charging, schedule of use, etc. In some embodiments, accessory 20 is a device that is releasably coupled to battery 14 and may be configured to display state of charge of the battery 14 or any other parameter. In some other embodiments, accessory 20 may comprise a component of vehicle 12 (such as a system configured to monitor and/or control vehicle parameters). In some embodiments, the components of vehicle 12 may communicate with BMS 16 using various protocols such as Controller Area Network (CAN) protocol.

System 10 may also include server 24 comprising server management unit 26, which may be configured to perform one or more functions as described herein such as determining a battery health condition and/or operation mode of battery 14, schedule a maintenance action based on the determined battery health condition and/or operation mode, etc.

It is contemplated that one or more entities of system 10 are in communication with each other via one or more of wireless communication, power communication, wired communication, etc. For example, vehicle 12, battery 14, accessory 20, and server 24 may communicate with each other directly or indirectly using wireless communication, power communication, wired communication, etc. Further, while it may be assumed in one or more embodiments that there is not data or signal communication between battery 14 and vehicle 12, the embodiments described herein are equally applicable to vehicles 12 where there are some data/signal communications between battery 14 and vehicle 12. Further, although battery 14 is shown as part of vehicle 12 may be a standalone battery, removably couplable to any component of system 10 such as vehicle 12, etc.

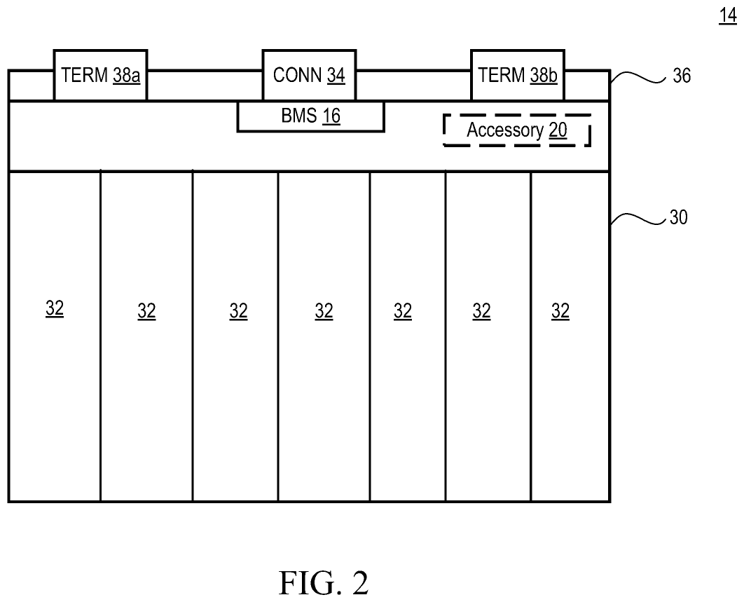

FIG. 2 shows an example battery 14 constructed in accordance with the principles of the present disclosure. Battery 14 includes a housing 30 into which one or more battery components may be positioned. The components may be electrically interconnected (not shown in the FIGS), such as via an electrically conductive bus bar system which electrically interconnects the components in an electrically serial, electrically parallel or combination of electrically serial and parallel manner, depending on the intended voltage and current requirements.

A battery monitoring system (BMS) 16 may be included in battery 14. BMS 16 may include a monitoring connector 34 that allows for a removable external connection any other component of system 10 (e.g., to the vehicle's data bus, to some other communication device, accessory 20, etc.) and/or internal connection, e.g., any components of battery 14 and/or BMS 16 and/or accessory 20. Connector 34 may be comprised in BMS 16 and/or accessory 20. In some embodiments, connector 34 may be configured to removably couple and/or connect (electrically, physically) to another connector. The monitoring connector 34 can, in some embodiments, be integrated with the housing 30, such as in a cover 36 of the housing 30. Battery 14 also includes terminals, such as a positive terminal 38a and a negative terminal 38b (collectively referred to as terminals 38) to provide the contact points for electrical connection of the battery 14 (e.g., to accessory 20 such as to power accessory 20, to the vehicle 12 such as to provide power to the vehicle and/or BMS 16 such as to power BMS 16). Terminals 38 may be arranged to protrude through housing 30, such as protruding through cover 36. Terminals 38 may be electrically connected to the bus bars inside housing 30 and/or directly connected to cells 32 (bus bars and direct connection not shown). In some embodiments, accessory 20 is comprised in battery 14. In some other embodiments, accessory 20 is in proximity to battery 14 and is connected to battery 14 such as for powering accessory 20 and in communication with BMS 16 (using a wired link such as a cable and a connector to connect to BMS 16, using a wireless link, etc.).

Further, battery 14 may be arranged to provide many power capacities and physical sizes, and to operate under various parameters and parameter ranges. It is also noted that implementations of battery 14 some can be scaled to provide various capacities. For example, in some embodiments, the power capacity of battery 14 can range from 25 Ah to 75 Ah. It is noted, however, that this range is merely an example, and that it is contemplated that embodiments of battery 14 can be arranged to provide less than a 25 Ah capacity or more than a 75 Ah capacity. Power capacity scaling can be accomplished, for example, by using higher or lower power capacity cells 32 in the housing 30, and/or by using fewer or more cells 32 in the housing 30. In some embodiments, battery 14 may be incorporated as part of a vehicle such as an electric vehicle (EV) or another type of vehicle where battery power is needed. Other electrical parameters of the battery 14 can be adjusted/accommodated by using cells 32 that may cumulatively have the desired operational characteristics, e.g., current, voltage, charging capacity/rate, discharge rate, etc. Thermal properties can be managed based on cell 32 characteristics, the use of heat sinks and/or thermal energy discharge plates, etc., within or external to the housing 30. Further, BMS 16 and/or accessory 20 may be connected to at least one of the cells such as to determine/measure at least one parameter of battery 14 and/or cells 32.

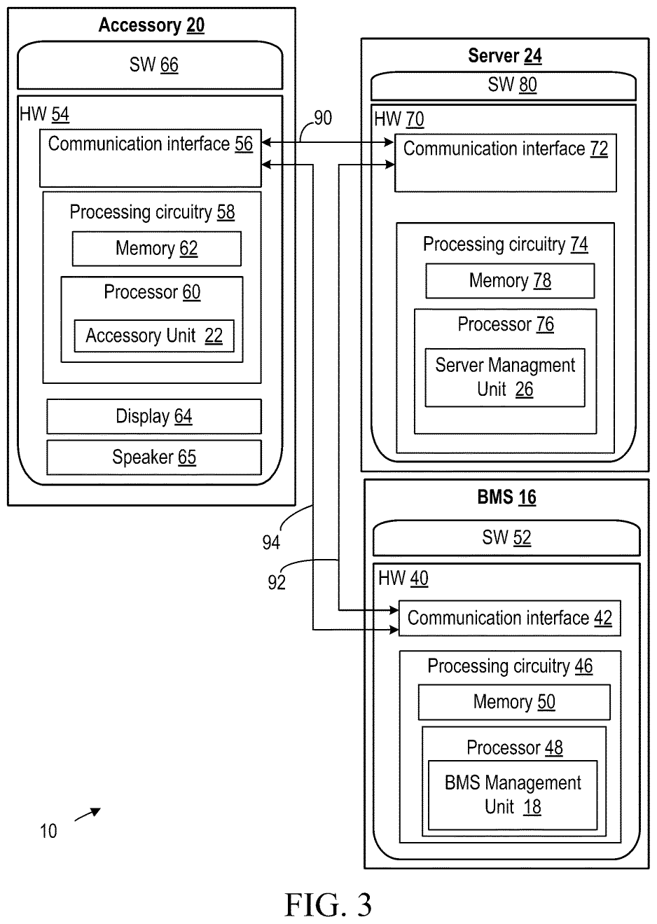

Example implementations, in accordance with an embodiment, of BMS 16, accessory 20, and server 24 discussed in the preceding paragraphs will now be described with reference to FIG. 3. BMS 16 may have hardware 40 that may include a communication interface 42 that is configured to communication with one or more entities in system 10 via wired and/or wireless communication. The communication may be protocol based communications.

The hardware 40 includes processing circuitry 46. The processing circuitry 46 may include a processor 48 and memory 50. In particular, in addition to or instead of a processor, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the BMS 16 may further comprise software 52, which is stored in, for example, memory 50, or stored in external memory (e.g., database, etc.) accessible by the BMS 16. The software 52 may be executable by the processing circuitry 46.

The processing circuitry 46 may be configured to control any of the methods and/or processes described herein and/or to cause such methods, and/or processes to be performed, e.g., by BMS 16. The processor 48 corresponds to one or more processors 48 for performing BMS 16 functions described herein. The BMS 16 includes memory 50 that is configured to store data, programmatic software code and/or other information described herein. In some embodiments, the software 52 may include instructions that, when executed by the processor 48 and/or processing circuitry 46, causes the processor 48 and/or processing circuitry 46 to perform the processes described herein with respect to BMS 16. For example, the processing circuitry 46 of the BMS 16 may include BMS management unit 18 that is configured to perform any step and/or task and/or process and/or method and/or feature described in the present disclosure, e.g., determine an operation mode of battery 14 and/or BMS 16 and/or accessory 20 such as based on at least one parameter and/or operate BMS 16 based on the determined operation mode. While BMS management unit 18 is illustrated as being part of BMS 16, BMS management unit 18 and associated functions described herein may be implemented in a device separate from BMS 16 such as in battery 14 or another device.

Accessory 20 may have hardware 54 that may include a communication interface 56 that is configured to communicate with one or more entities in system 10 (and/or outside of system 10) via wired and/or wireless communication. The communication may be protocol based communication. Accessory 20 may also be configured to electrically connect to battery 14, e.g., to power accessory 20 and/or receive at least one parameter (and/or parameter data) from BMS 16 of battery 14 and/or transmit at least one parameter (and/or parameter data) to BMS 16 of battery 14 and/or display information such as associated with at least one parameter and/or receive a user input.

The hardware 54 includes processing circuitry 58. The processing circuitry 58 may include a processor 60 and memory 62. In particular, in addition to or instead of a processor, such as a central processing unit, and memory, the processing circuitry 58 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 60 may be configured to access (e.g., write to and/or read from) memory 62, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Accessory 20 may further comprise software 66, which is stored in, for example, memory 62, or stored in external memory (e.g., database, etc.) accessible by the accessory 20. The software 66 may be executable by the processing circuitry 58.

The processing circuitry 58 may be configured to control any of the methods and/or processes described herein and/or to cause such methods, and/or processes to be performed, e.g., by accessory 20. The processor 60 corresponds to one or more processors 60 for performing accessory 20 functions described herein. The accessory 20 includes memory 62 that is configured to store data, programmatic software code and/or other information described herein. In some embodiments, the software 66 may include instructions that, when executed by the processor 60 and/or processing circuitry 58, causes the processor 60 and/or processing circuitry 58 to perform the processes described herein with respect to accessory 20. For example, the processing circuitry 58 of accessory 20 may include accessory unit 22 configured to perform any step and/or task and/or process and/or method and/or feature described in the present disclosure, e.g., determine an operation mode such as received from BMS 16 and operate based on the operation mode. Accessory 20 may also include display 64 configured to display information (e.g., an indication) associated with battery 14 such as a measured/determined a parameter or any other information. The parameter may include state of charge, voltage, current, etc. Display 64 may comprise a light such as a light emitting diode (LED), a monitor, a screen, and/or any other type of display. Accessory 20 may further include speaker 65 which is configured to annunciate values of parameters, alarms, status indications, or any other information such as information that is displayed by display 64 or information associated with any of the components of system 10. In some embodiments, speaker 65 is a piezoelectric speaker.

In some embodiments, accessory 20 and/or any of its components such as display 64 may be comprised in BMS 16 (and/or battery 14) and/or be powered by BMS 16 (and/or battery 14).

Further, server 24 includes hardware 70, and the hardware 28 may include a communication interface 72 for performing wired and/or wireless communication with BMS 16 and/or accessory 20 and/or any other device. For example, communication interface 72 of server 24 may communicate with communication interface 56 of accessory 20 via communication link 90. In addition, communication interface 72 of server 24 may communicate with communication interface 42 of BMS 16 via communication link 92. Similarly, communication interface 42 may communicate with communication interface 56 via communication link 94. At least one of communication links 90, 92, 94 may refer to a wired/wireless connection (such as WiFi, Bluetooth, etc.).

In the embodiment shown, the hardware 70 of server 24 includes processing circuitry 74. The processing circuitry 74 may include a processor 76 and a memory 78. In particular, in addition to or instead of a processor, such as a central processing unit, and memory, the processing circuitry 74 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 76 may be configured to access (e.g., write to and/or read from) the memory 78, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the server 24 further has software 80 stored internally in, for example, memory 78, or stored in external memory (e.g., database, etc.) accessible by the server 24 via an external connection. The software 80 may be executable by the processing circuitry 74. The processing circuitry 74 may be configured to control any of the methods and/or processes described herein and/or to cause such methods, and/or processes to be performed, e.g., by server 24. Processor 76 corresponds to one or more processors 76 for performing server 24 functions described herein. The memory 78 is configured to store data, programmatic software code and/or other information described herein. In some embodiments, the software 80 may include instructions that, when executed by the processor 76 and/or processing circuitry 74, causes the processor 76 and/or processing circuitry 74 to perform the processes described herein with respect to server 24. For example, processing circuitry 74 of server 24 may include server management unit 26 that is configured to perform one or more server 24 functions as described herein, e.g., determine one or more operation modes such as indicated by BMS 16 and/or perform at least one action based on the one or more operation modes such as schedule maintenance, transmit an alert, etc.

Although server 24 may comprise a physical server, virtualized server, or other computing device, server 24 may also be a mobile device such as a smart phone, wearable, etc. In some embodiments, software 84 may include a software application which may be configured for Bluetooth communication or other communication protocol. The software application may allow a user to set alarms (e.g., alarms associated with battery 14) based on various parameters. The alarms may alert the user via their mobile device. Having the software application on the mobile device provides flexibility for the user to set or adjust parameters, intervals, modes based on their specific use case. In some embodiments, the mobile device features described with respect to server 24 may be performed by accessory 20 and its components, such as where accessory 20 is a mobile device.

In some embodiments, accessory 20 may be comprised in a BMS 16 and/or battery 14 (as shown in FIG. 2) and/or be standalone. In some other embodiments, accessory 20 may be configured to perform any BMS function.

Although FIGS. 1 and 3 show one or more “units” such as BMS management unit 18, accessory unit 22, server management unit 26 as being within a respective processor, it is contemplated that these units may be implemented such that a portion of the unit is stored in a corresponding memory within the processing circuitry. In other words, the units may be implemented in hardware, software or in a combination of hardware and software within the processing circuitry.

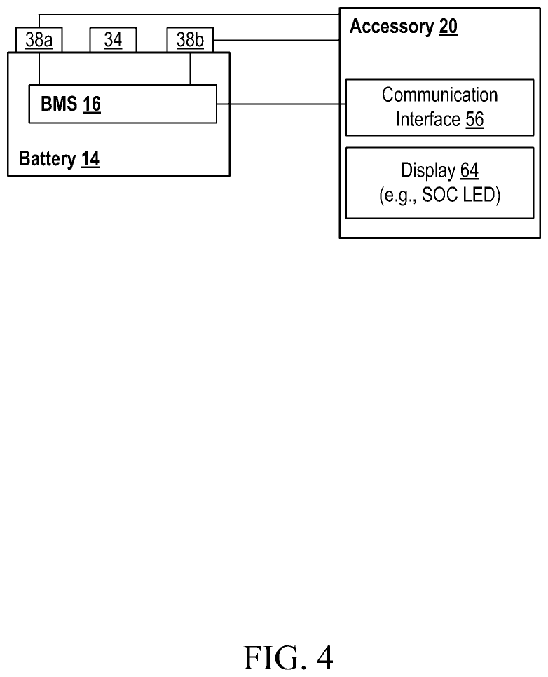

FIG. 4 shows an example BMS 16 according to some embodiments of the present disclosure. More specifically, the BMS 16 may be comprised in (e.g., as part of) battery 14 and be powered by battery 14 such as via terminals 38a, 38b. Further, BMS 16 may be configured to connect to and communicate with accessory 20 (which may also be powered by battery 14 via terminals 38a, 38b) via communication interface 56 of accessory 20 such as to transmit and/or receive at least one parameter and/or associated data. Accessory 20 may be configured to display information such as information associated with the parameter (e.g., state of charge of battery 14) and/or any other information on display 64. In a nonlimiting example, display 64 may be configured to display a state of charge (SOC) of battery 14. The display 64 may include a plurality of LEDs for displaying information. In another nonlimiting example, display 64 may display an operation mode, a schedule associated with battery 14, a time period that battery 14 is expected to be stored, without charging, charging, etc.

When the BMS 16 and/or accessory 20 are electrically connected to battery 14 power is consumed, which may cause the SOC of the battery 14 to decrease over time and/or discharge. BMS 16 (and/or BMS management unit 18) may be configured to determine an operation mode of the BMS 16 and/or accessory 20 based at least one parameter, such as to reduce the power consumed by the BMS 16 and/or accessory 20, e.g., to prolong the state of charge of battery 14, decrease the rate of discharge of battery 14, decrease the rate of change of the SOC, etc.

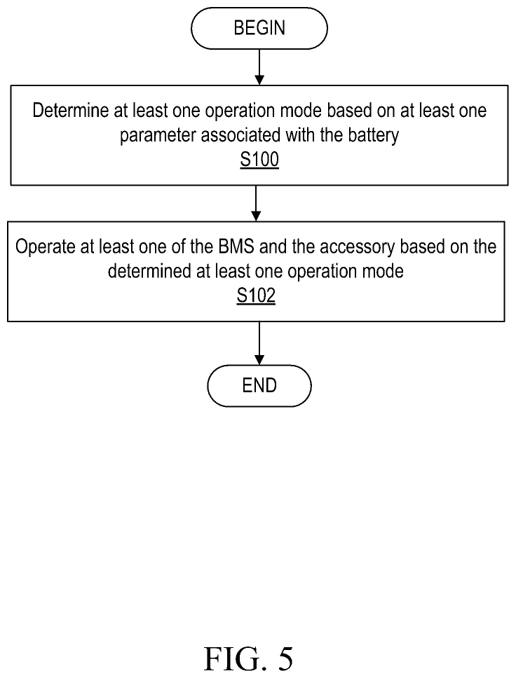

FIG. 5 is a flowchart of an example process (i.e., method) in BMS 16 according to some embodiments of the present invention. One or more blocks described herein may be performed by one or more elements of BMS 16 such as by one or more of processing circuitry 46 (including the BMS management unit 18), processor 48, and/or communication interface 42. BMS 16 is configured to determine (Block S100) at least one operation mode based on at least one parameter associated with the battery 14; and operate at least one of the BMS 16 and the accessory 20 based on the determined at least one operation mode.

In some embodiments, the at least one operation mode includes at least one of a first operation mode corresponding to a first range of the at least one parameter; a second operation mode corresponding to a second range of the at least one parameter; and a third operation mode corresponding to third range of the at least one parameter.

In some other embodiments, the method further includes at least one of determining a first time interval and a second time interval for at least one of the first, second, and third operation modes based on the at least one parameter. The first time interval indicates the BMS 16 is to be on during the first time interval. The second time interval indicates the BMS 16 is to be in a BMS sleep state (e.g., a state where the BMS 16 is operated not to exceed a power threshold and may include the BMS being off) during the second time interval. The first and second time intervals are consecutive. The method further includes determining a third time interval and a fourth time interval for at least one of the first, second, and third operation modes based on the at least one parameter. The third time interval indicates the accessory 20 is to be on during the third time interval, and the fourth time interval indicates the accessory 20 is to be off during the fourth time interval. The third and fourth time intervals are consecutive.

In an embodiment, the operation of at least one of the BMS 16 and the accessory 20 includes operating the BMS 16 based on the first and second time intervals; and operating the accessory 20 based on the third and fourth time intervals.

In another embodiment, the method further includes at least one of determining a power consumption for each one of the at least one operation mode and each one of the BMS 16 and the accessory 20 based on a parameter threshold associated with the at least one parameter; determining a battery operation time interval for which the battery 14 can be operated until the parameter threshold is reached based on the determined power consumption; and determining at least one other operation mode based on the power consumption and the battery operation time interval; operating at least one of the BMS 16 and the accessory 20 based on the determined at least one other operation mode.

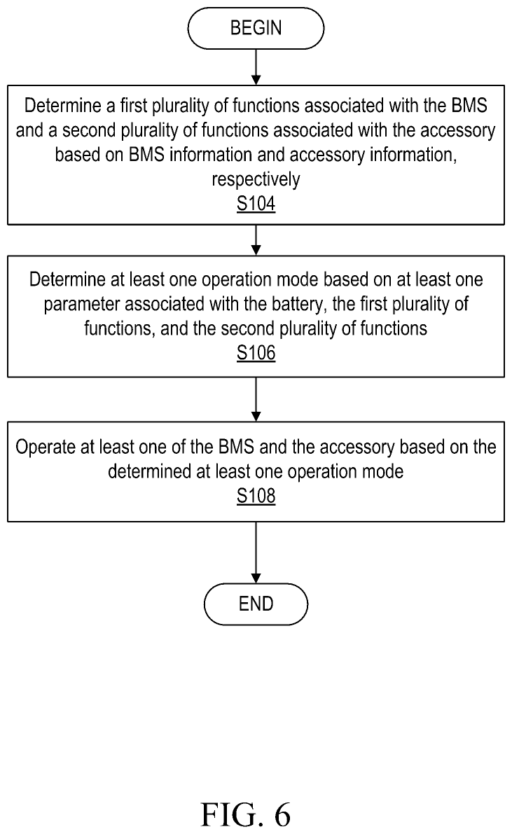

FIG. 6 is a flowchart of another example process (i.e., method) in BMS 16 according to some embodiments of the present invention. One or more blocks described herein may be performed by one or more elements of BMS 16 such as by one or more of processing circuitry 46 (including the BMS management unit 18), processor 48, and/or communication interface 42. BMS 16 is configured to determine (Block S104) a first plurality of functions associated with the BMS 16 and a second plurality of functions associated with the accessory 20 based on BMS information and accessory information, respectively, determine (Block S106) at least one operation mode based on at least one parameter associated with the battery 14, the first plurality of functions, and the second plurality of functions, operate (Block S108) at least one of the BMS 16 and the accessory 20 based on the determined at least one operation mode.

In some embodiments, the method further includes at least one of: (A) determining a first time interval and a second time interval for the at least one operation mode based at least on the at least one parameter, the first and second time intervals being consecutive; and (B) determining a third time interval and a fourth time interval for the at least one operation mode based at least on the at least one parameter, the third and fourth time intervals being consecutive.

In some other embodiments, the operation of at least one of the BMS 16 and the accessory 20 includes operating the BMS 16 based on the first time interval and the second time interval and operating the accessory 20 based on the third time interval and the fourth time interval.

In some embodiments, at least one of: (A) operating the BMS 16 based on the first time interval includes keeping the BMS 16 on during the first time interval; (B) operating the BMS 16 based on the second time interval includes keeping the BMS 16 in a BMS sleep state during the first time interval; (C) operating the accessory 20 based on the third time interval includes keeping the accessory 20 on during the third time interval; and (D) operating the accessory 20 based on the fourth time interval includes keeping the accessory 20 in an accessory sleep state during the fourth time interval.

In some other embodiments, the method further includes determining a first set of functions of the first plurality of functions associated with the BMS 16 and a second set of functions of the second plurality of functions associated with the accessory 20 based on a function characteristic of each one of the first of the first plurality of functions and the second plurality of functions.

In some embodiments, the function characteristic indicates at least one of a criticality level of the corresponding function and whether the function is associated with a battery health condition.

In some other embodiments, the method further includes determining a frequency at which each function of the first plurality of functions and the second plurality of functions is to be performed based on at least one of the function characteristic, whether the function is in the first set or the second set, and power consumption of the function.

In some embodiments, the method further includes performing at least one function of the first plurality of functions to operate the BMS 16 and performing at least one function of the second plurality of functions to operate the accessory 20.

In some other embodiments, the method further includes receiving, from the accessory 20, an indication indicating a storage schedule of the battery 14, the at least one operation mode being determined further based on the storage schedule.

In some embodiments, the at least one operation mode includes at least one of: (A) a first operation mode corresponding to a first range of the at least one parameter, the first operation mode having a first power consumption of the BMS 16 and a second power consumption of the accessory 20; (B) a second operation mode corresponding to a second range of the at least one parameter, the second operation mode having a third power consumption of the BMS 16 and a fourth power consumption of the accessory 20; and a third operation mode corresponding to third range of the at least one parameter, the third operation mode having a fifth power consumption of the BMS 16 and a sixth power consumption of the accessory 20. Each power consumption of the BMS 16 is different, and each power consumption of the accessory 20 is different.

In some other embodiments, the first range includes a first plurality of values of the at least on parameter, the second range include a second plurality of values of the at least one parameter, the third range includes a third plurality of values of the at least one parameter. Each value of the second plurality of values is greater than each value of the first plurality of values, and each value of the third plurality of values is greater than each value of the second plurality of values.

In some embodiments, the method further includes at least one of: (A) determining a power consumption for each one of the at least one operation mode and each one of the BMS 16 and the accessory 20 based on a parameter threshold associated with the at least one parameter;
determining a battery operation time interval for which the battery 14 can be operated until the parameter threshold is reached based on the determined power consumption;
determining at least one other operation mode based on the power consumption and the battery operation time interval; and
before the operation time interval is reached, operating at least one of the BMS 16 and the accessory 20 based on the determined at least one other operation mode.

Having described the general process flow of arrangements of the disclosure and having provided examples of hardware and software arrangements for implementing the processes and functions of the disclosure, the sections below provide details and examples of arrangements for one or more processes related to power management of an energy storage module (e.g., lithium battery).

Typical hardware based battery systems may seek to operate using low power consumption but lack flexibility in execution of features. Further, power consumption from a typical software based battery systems can consume a significant amount of a battery energy, storage capacity, especially in relatively small capacity batteries that are typically used for powersports applications. This energy consumption can result in the battery becoming discharged below usable capacity levels in a short time (e.g., days or a few weeks).

One or more embodiments of the present disclosure provide reduction of power consumption (e.g., by a BMS 16) when compared to typical systems. Further, a time period that the battery 14 can remain functional between usage or charge cycles may be improved with respect to typical systems.

In some embodiments, a BMS 16 may operate using one or more operation modes such as normal, sleep, and shutdown, with progressively decreasing power consumption levels. The use of these different operation modes may be linear and generally changes based on external inputs (e.g., current flow) or lack thereof. BMS 16 may also cause accessory 20 to operate using the operation modes of the BMS 16 or operate using another operation mode based on the operation modes of the BMS 16.

In one or more embodiments, power consumption by the BMS 16 is reduced at least by alternating between a first operation mode and a second operation mode such as between normal and low power consumption modes. The first and second operation modes may be alternated periodically. In some embodiments, the BMS 16 may check (e.g., redundantly) at least one parameter such as system parameters at a certain frequency. The checks may be performed when the BMS 16 is activated (i.e., operated in a predetermined operation mode, triggered to be operated in the predetermined operation mode). Some of the parameters may include temperature, voltage, current, etc. The BMS 16 may be configured to return to the second operation mode (e.g., low power consumption mode) such as after a predetermined interval of time.

In some other embodiments, the frequency of checks (e.g., frequency of system checks) may be greater when SOC is above a predetermined SOC threshold than when SOC is at or below the predetermined SOC threshold. In a nonlimiting example, at 90% state of charge, the frequency of checks may be once every five seconds, while at 50% state of charge the frequency of checks may be once every fifteen seconds. That is, the time between system checks may be increased at lower states of charge, such as to conserve battery charge.

In an embodiment, the duration of time the BMS 16 is activated (e.g., is on, not in sleep state, etc.) for its system check functions may be minimized based on a parameter, such as an expected time of storage of the battery, state of charge, type and quantity of accessories 20 connected to battery 14, battery load, etc.

In another embodiment, battery 14 may include an accessory 20 and/or display 64 (e.g., an LED) to indicate state of charge and/or battery state and/or battery storage schedule, etc. The duration of time the BMS 16 and/or display 64 (e.g., LED) and/or accessory 20 is activated (i.e., on, operated in a predetermined operation mode, triggered to be operated in the predetermined operation mode) and/or deactivated may be changed (e.g., decreased or increased) or maintained by BMS 16 based on a parameter such as a predetermined power consumption parameter, state of charge, battery storage schedule, etc. In one nonlimiting example, BMS 16 may set the duration of time for performing BMS functions such that a predetermined reduction in power consumption (e.g., accessory power consumption, BMS power consumption, system power consumption, etc.) is achieved. Similarly, BMS 16 may set the duration of time for performing accessory functions such as the time the display 64 and/or accessory 20 is on such that a predetermined reduction in power consumption (e.g., accessory power consumption, BMS power consumption, system power consumption, etc.) is achieved.

In some embodiments, BMS 16 determines a plurality of BMS functions and/or a plurality of accessory functions. Further, BMS 16 may determine a first time interval such as a BMS on time and/or a second time interval such as an accessory on time. The first time interval may be the time in which BMS 16 is allowed to perform the plurality of BMS functions, and the second time interval may be the time in which accessory 20 is allowed to perform the plurality of accessory functions. In some other embodiments, BMS 16 may change or maintain the first time interval and/or the second time interval for performing the corresponding plurality of functions.

In some embodiments, BMS 16 determines a set of the plurality of BMS functions and/or a set of the plurality of accessory functions based one on a parameter. Further, BMS 16 may determine a third time interval and/or a fourth time interval. The third time interval may be the time in which BMS 16 is allowed to perform the set of BMS functions, and the fourth time interval may be the time in which accessory 20 is allowed to perform the set of accessory functions.

In some other embodiments, BMS 16 may change or maintain the first time interval, the second time interval, the third time interval, and/or the fourth time interval based on a parameter. For example, BMS 16 may reduce the first time interval and/or the second time interval when the state of charge is lower than a predetermined threshold and/or the battery is expected to be stored without charging for a predetermined duration of time (e.g., winter season). BMS 16 may also reduce the functions that are performed by BMS 16 and accessory 20 to a set of functions (e.g., a state of health check by BMS 16, state of charge check by BMS 16, display only state of health, state of charge, etc.). In addition, BMS 16 may also reduce the third time interval and/or fourth time interval when the state of charge is lower than a predetermined threshold and/or the battery is expected to be stored without charging for a predetermined duration of time (e.g., winter season). In some embodiments, BMS 16 determines priorities of BMS functions and accessory functions to determine which functions to perform or not perform, determine the order of functions, the scheduling of functions, etc. In one or more embodiments, BMS on time may be reduced for the BMS 16 to perform a subset of the functions. The subset of functions may include functions having a higher criticality for the BMS 16 and battery 14 than other functions not included in the subset.

In some other embodiments, battery 14 (comprising BMS 16) is placed in storage (e.g., disconnected from vehicle 12). However, storage time, BMS sleep mode and storage temperature may determine (and/or influence) self-discharge. An interval of time (and/or self-discharge rate) where at least one parameter exceeds a parameter threshold while battery 14 is in storage may be determined by BMS 16 based at least in part on self-discharge rate.

In some embodiments, a first interval of time (e.g., on time of the BMS 16 and/or display 64) and a second interval of time (e.g. off/sleep time of the BMS 16 and/or display 64) may be determined based on at least one parameter such as SOC. Further, power consumption per interval of time may be determined based on a component that is not off (i.e., consuming power), the amount of power, and the interval of time that power is consumed, e.g., BMS power, accessory power, BMS on time, accessory on time, etc. In some other embodiments, a total time per operation mode may be determined/estimated based on a rate of power consumption.

In one or more embodiments, one or more operation modes may correspond to one or more ranges (or subranges) associated with at least one parameter such as SOC. Each operation mode may be associated with a battery capacity, a total current, and a total duration of time elapsed in the operation mode. In some embodiments, one or more components of the BMS 16, external components (e.g., connected to the BMS 16 and/or battery 14), and/or the BMS 16 may consume power when activated and/or operated. For example, accessory 20 (and/or display 64 such as an LED) may be electrically connected to the battery 14 and consuming power such as to perform accessory functions. Similarly, the BMS 16 may be electrically connected to the battery and consuming power such as to perform BMS functions. BMS 16 may determine an expected power consumption for each of the functions performed by BMS 16 and accessory 20, to predict a power consumption and determine time intervals in which functions are allowed to be performed such as to achieve a state of charge target at a future time.

In some embodiments, a first time interval (e.g., BMS on time) and a second time interval (e.g., BMS sleep state, BMS off time, time where BMS is not off, etc.) for at least one operation mode may be determined based on the at least one parameter such as SOC, subrange of SOC, etc. The first time interval may indicate the BMS 16 is to be on during the first time interval. The second time interval may indicate the BMS 16 is to be on a BMS sleep state during the second time interval. The first and second time intervals may be consecutive, e.g., where the BMS 16 switches to on, then to off (or sleep state) and back to on periodically. For example, the BMS 16 may be switched to on (i.e., be activated) to perform BMS functions during the first time interval. When the first time interval elapses, the BMS 16 may be switched to a sleep state (or switched off) during the second time interval. When the second time interval elapses, the BMS 16 may be switched on again. In some other embodiments, the operation mode (and/or corresponding parameters, time intervals, etc.) may be adjusted and/or updated to achieve predetermined goal such as a total duration of time at least one parameter meets a parameter threshold, e.g., without re-charging the battery 14.

In some other embodiments, a third time interval and a fourth time interval for at least one operation mode is determined based on the at least one parameter. The third time interval may indicate the accessory 20 is to be on during the third time interval, and the fourth time interval indicating the accessory is to be off during the fourth time interval. The third and fourth time intervals may be consecutive. That is, accessory 20 (and/or any of its components) may be turned on during the third time interval, and when the third time interval expires, accessory 20 may be turned off during the fourth time interval. Accessory 20 may be turned on again after expiration of the fourth time interval.

The following is a nonlimiting list of embodiments.

1. A battery management system, BMS, 16 removably connectable to at least one of a battery 14 and an accessory 20, the accessory 20 being operable by the BMS 16, the BMS 16 comprising processing circuitry 46 configured to:
determine at least one operation mode based on at least one parameter associated with the battery 14; and
operate at least one of the BMS 16 and the accessory 20 based on the determined at least one operation mode.

2. The BMS 16 of Claim 1, wherein the at least one operation mode includes at least one of:
a first operation mode corresponding to a first range of the at least one parameter;
a second operation mode corresponding to a second range of the at least one parameter; and
a third operation mode corresponding to third range of the at least one parameter.

3. The BMS 16 of Claim 2, wherein the processing circuitry 46 is further configured to at least one of:
determine a first time interval and a second time interval for at least one of the first, second, and third operation modes based on the at least one parameter, the first time interval indicating the BMS 16 is to be on during the first time interval, the second time interval indicating the BMS 16 is to be on a BMS sleep state during the second time interval, the first and second time intervals being consecutive; and
determine a third time interval and a fourth time interval for at least one of the first, second, and third operation modes based on the at least one parameter, the third time interval indicating the accessory 20 is to be on during the third time interval, the fourth time interval indicating the accessory 20 is to be off during the fourth time interval, the third and fourth time intervals being consecutive.

4. The BMS 16 of Claim 3, wherein the operation of at least one of the BMS 16 and the accessory 20 includes:
operating the BMS 16 based on the first and second time intervals; and
operating the accessory 20 based on the third and fourth time intervals.

5. The BMS 16 of any one of Claims 1-4, wherein the processing circuitry 46 is further configured to at least one of:
determine a power consumption for each one of the at least one operation mode and each one of the BMS 16 and the accessory 20 based on a parameter threshold associated with the at least one parameter;
determine a battery operation time interval for which the battery 14 can be operated until the parameter threshold is reached based on the determined power consumption;
determine at least one other operation mode based on the power consumption and the battery operation time interval; and
operate at least one of the BMS 16 and the accessory 20 based on the determined at least one other operation mode.

6. A method in a battery management system, BMS 16, removably connectable to at least one of a battery 14 and an accessory 20, the accessory 20 being operable by the BMS 16, the method comprising:
determining (S100) at least one operation mode based on at least one parameter associated with the battery 14); and
operating (S102) at least one of the BMS 16 and the accessory 20 based on the determined at least one operation mode.

7. The method of Claim 6, wherein the at least one operation mode includes at least one of:
a first operation mode corresponding to a first range of the at least one parameter;
a second operation mode corresponding to a second range of the at least one parameter; and
a third operation mode corresponding to third range of the at least one parameter.

8. The method of Claim 7, wherein the method further includes at least one of:
determining a first time interval and a second time interval for at least one of the first, second, and third operation modes based on the at least one parameter, the first time interval indicating the BMS 16 is to be on during the first time interval, the second time interval indicating the BMS 16 is to be on a BMS sleep state during the second time interval, the first and second time intervals being consecutive; and
determining a third time interval and a fourth time interval for at least one of the first, second, and third operation modes based on the at least one parameter, the third time interval indicating the accessory 20 is to be on during the third time interval, the fourth time interval indicating the accessory 20 is to be off during the fourth time interval, the third and fourth time intervals being consecutive.

9. The method of Claim 8, wherein the operation of at least one of the BMS 16 and the accessory 20 includes:
operating the BMS 16 based on the first and second time intervals; and
operating the accessory 20 based on the third and fourth time intervals.

10. The method of any one of Claims 6-9, wherein the method further includes at least one of:
determining a power consumption for each one of the at least one operation mode and each one of the BMS 16 and the accessory 20 based on a parameter threshold associated with the at least one parameter;
determining a battery operation time interval for which the battery 14 can be operated until the parameter threshold is reached based on the determined power consumption;
determining at least one other operation mode based on the power consumption and the battery operation time interval; and
operating at least one of the BMS 16 and the accessory 20 based on the determined at least one other operation mode.

11. A battery comprising the BMS 16 according to any one of Claims 1-5.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings and the following claims.

1. A battery management system, BMS, removably connectable to at least one of a battery and an accessory, the accessory being operable by the BMS, the BMS comprising processing circuitry configured to:
determine a first plurality of functions associated with the BMS and a second plurality of functions associated with the accessory based on BMS information and accessory information, respectively;
determine at least one operation mode based on at least one parameter associated with the battery, the first plurality of functions, and the second plurality of functions; and
operate at least one of the BMS and the accessory based on the determined at least one operation mode.

2. The BMS of claim 1, wherein the processing circuitry is further configured to at least one of:
determine a first time interval and a second time interval for the at least one operation mode based at least on the at least one parameter, the first and second time intervals being consecutive; and
determine a third time interval and a fourth time interval for the at least one operation mode based at least on the at least one parameter, the third and fourth time intervals being consecutive.

3. The BMS of claim 2, wherein the operation of at least one of the BMS and the accessory includes:
operating the BMS based on the first time interval and the second time interval; and
operating the accessory based on the third time interval and the fourth time interval.

4. The BMS of claim 3, wherein at least one of:
operating the BMS based on the first time interval includes keeping the BMS on during the first time interval;
operating the BMS based on the second time interval includes keeping the BMS in a BMS sleep state during the first time interval;
operating the accessory based on the third time interval includes keeping the accessory on during the third time interval; and
operating the accessory based on the fourth time interval includes keeping the accessory in an accessory sleep state during the fourth time interval.

5. The BMS of claim 1, wherein the processing circuitry is further configured to:
determine a first set of functions of the first plurality of functions associated with the BMS and a second set of functions of the second plurality of functions associated with the accessory based on a function characteristic of each one of the first of the first plurality of functions and the second plurality of functions.

6. The BMS of claim 5, wherein the function characteristic indicates at least one of a criticality level of the corresponding function and whether the function is associated with a battery health condition.

7. The BMS of claim 5, wherein the processing circuitry is further configured to:
determine a frequency at which each function of the first plurality of functions and the second plurality of functions is to be performed based on at least one of the function characteristic, whether the function is in the first set or the second set, and power consumption of the function.

8. The BMS of claim 1, wherein the processing circuitry is further configured to:
perform at least one function of the first plurality of functions to operate the BMS; and
perform at least one function of the second plurality of functions to operate the accessory.

9. The BMS of claim 1, wherein the processing circuitry is further configured to:
receive, from the accessory, an indication indicating a storage schedule of the battery, the at least one operation mode being determined further based on the storage schedule.

10. The BMS of claim 1, wherein the at least one operation mode includes at least one of:
a first operation mode corresponding to a first range of the at least one parameter, the first operation mode having a first power consumption of the BMS and a second power consumption of the accessory;
a second operation mode corresponding to a second range of the at least one parameter, the second operation mode having a third power consumption of the BMS and a fourth power consumption of the accessory; and
a third operation mode corresponding to third range of the at least one parameter, the third operation mode having a fifth power consumption of the BMS and a sixth power consumption of the accessory, each power consumption of the BMS being different, each power consumption of the accessory being different.

11. The BMS of claim 10, wherein the first range includes a first plurality of values of the at least on parameter, the second range include a second plurality of values of the at least one parameter, the third range includes a third plurality of values of the at least one parameter, each value of the second plurality of values is greater than each value of the first plurality of values, and each value of the third plurality of values is greater than each value of the second plurality of values.

12. The BMS of claim 1, wherein the processing circuitry is further configured to at least one of:
determine a power consumption for each one of the at least one operation mode and each one of the BMS and the accessory based on a parameter threshold associated with the at least one parameter;
determine a battery operation time interval for which the battery can be operated until the parameter threshold is reached based on the determined power consumption;
determine at least one other operation mode based on the power consumption and the battery operation time interval; and
before the operation time interval is reached, operate at least one of the BMS and the accessory based on the determined at least one other operation mode.

13. A method in a battery management system, BMS, removably connectable to at least one of a battery and an accessory, the accessory being operable by the BMS the method comprising:
determining a first plurality of functions associated with the BMS and a second plurality of functions associated with the accessory based on BMS information and accessory information, respectively;
determining at least one operation mode based on at least one parameter associated with the battery, the first plurality of functions, and the second plurality of functions; and
operating at least one of the BMS and the accessory based on the determined at least one operation mode.

14. The method of claim 13, wherein the method further includes at least one of:
determining a first time interval and a second time interval for the at least one operation mode based at least on the at least one parameter, the first and second time intervals being consecutive; and
determining a third time interval and a fourth time interval for the at least one operation mode based at least on the at least one parameter, the third and fourth time intervals being consecutive.

15. The method of claim 14, wherein the operation of at least one of the BMS and the accessory includes:
operating the BMS based on the first time interval and the second time interval; and
operating the accessory based on the third time interval and the fourth time interval.

16. The method of claim 15, wherein at least one of:
operating the BMS based on the first time interval includes keeping the BMS on during the first time interval;
operating the BMS based on the second time interval includes keeping the BMS in a BMS sleep state during the first time interval;
operating the accessory based on the third time interval includes keeping the accessory on during the third time interval; and
operating the accessory based on the fourth time interval includes keeping the accessory in an accessory sleep state during the fourth time interval.

17-21. (canceled)

22. The method of claim 13, wherein the at least one operation mode includes at least one of:
a first operation mode corresponding to a first range of the at least one parameter, the first operation mode having a first power consumption of the BMS and a second power consumption of the accessory;
a second operation mode corresponding to a second range of the at least one parameter, the second operation mode having a third power consumption of the BMS and a fourth power consumption of the accessory; and
a third operation mode corresponding to third range of the at least one parameter, the third operation mode having a fifth power consumption of the BMS and a sixth power consumption of the accessory, each power consumption of the BMS being different, each power consumption of the accessory being different.

23. The method of claim 22, wherein the first range includes a first plurality of values of the at least on parameter, the second range include a second plurality of values of the at least one parameter, the third range includes a third plurality of values of the at least one parameter, each value of the second plurality of values is greater than each value of the first plurality of values, and each value of the third plurality of values is greater than each value of the second plurality of values.

24. The method of claim 13, wherein the method further includes at least one of:
determining a power consumption for each one of the at least one operation mode and each one of the BMS and the accessory based on a parameter threshold associated with the at least one parameter;
determining a battery operation time interval for which the battery can be operated until the parameter threshold is reached based on the determined power consumption;
determining at least one other operation mode based on the power consumption and the battery operation time interval; and
before the operation time interval is reached, operating at least one of the BMS and the accessory based on the determined at least one other operation mode.

25. A system comprising:
a battery;
a battery management system, BMS, coupled to the battery;
an accessory coupled to the battery and the BMS, the accessory being operable by the BMS;
the BMS comprising processing circuitry configured to:
determine a first plurality of functions associated with the BMS and a second plurality of functions associated with the accessory based on BMS information and accessory information, respectively;
determine a first set of functions of the first plurality of functions associated with the BMS and a second set of functions of the second plurality of functions associated with the accessory based on a function characteristic of each one of the first of the first plurality of functions and the second plurality of functions, the function characteristic indicating at least one of a criticality level of the corresponding function and whether the function is associated with a battery health condition;
determine at least one operation mode based on at least one parameter associated with the battery, the first plurality of functions, the second plurality of functions, the first set of functions, and the second set of functions;
operate at least one of the BMS and the accessory based on the determined at least one operation mode, the operation of at least one of the BMS and the accessory including:
performing at least one function of the first set of functions or the first plurality of functions to operate the BMS; and
perform at least one function of the second set of functions or the second plurality of functions to operate the accessory.
